(19) United States
(12) Patent Application Publication
(10) Pub. No.: US 2004/0049473 A1
(43) Pub. Date: Mar. 11, 2004

(54) Information analytics systems and methods

(76) Inventors: David John Gower, Blacklick, OH (US); James Michael Brennan, West Worthington, OH (US); David Alford Burgoon, Columbus, OH (US); Steven Cohen, Dublin, OH (US); Christine Marie Long, Chicago, IL (US); Robert David Quinn, Delaware, OH (US); Dov Stuart Rosenberg, Bexley, OH (US)

Correspondence Address: Killworth, Gottman, Hagan & Schaeff, L.L.P., Suite 500, One Dayton Centre, Dayton, OH, 45402-2023, US

(21) Appl. No.: 10/235,403

(22) Filed: Sep. 5, 2002

(51) Int. Cl. G06F 7/00; G06N 5/04; G06F 17/00; G06N 5/02; G06F 15/18

(52) U.S. Cl. 706/46; 707/100; 707/104.1; 706/12

(57) ABSTRACT

One aspect of the present invention relates to methods and systems that utilize harvested data to predict results, populate predictive models, and allow decisions to be made. Internal structured data is grouped into items of interest and an event of interest is tagged. Data including unstructured and structured data is harvested, and the harvested data is analyzed to determine whether a predictive model exists between the harvested data and the selected group. A mathematical signature is computed based upon the external data in order to establish the predictive model. Thus the harvested information may be used to build, modify, or test predictive models of internal results based upon external events.

### BACKGROUND OF THE INVENTION

The present invention relates in general to information management, and in particular to systems and methods for analyzing information by harvesting data and utilizing the harvested data to predict results, populate predictive models, make decisions, and allow decisions to be made.

It is commonplace in virtually every business sector to make decisions based upon incomplete and sometimes imperfect information. For example, businesses make decisions every day as to what markets to enter or leave, which products to develop, what customers and prospects to sell to, and what prices to set. Such decisions must be made despite the risks of economic fluctuations, loss exposures, supply chain disruptions, competitive activity, technology advances, regulatory changes, and other disruptive events.

At certain times, business decisions are made based upon incomplete information as a result of an attempt to balance appropriate timing to take advantage of business opportunities versus minimizing the risk of that opportunity. However, often times, business decisions are also made without considering important information that is readily available. Vital business information can be found in an ever-increasing number of forms including structured data, such as databases, and unstructured information, such as emails, web pages, and word processing documents. Structured and unstructured information may be provided by internal sources, such as business systems, and from external sources, such as the Internet, subscription services, news groups, and bulletin board services. Buried in all the vital business intelligence is information that can help companies anticipate events that create new opportunities or assess risks.

Despite the volumes of accessible data, a burden is placed on the decision maker due to the onerous task of sorting through and extracting relevant information from the sheer volume of data available. Further, the available data is often scattered across diverse locations and is sometimes only available in incompatible formats. As such, decision makers may be completely unaware of the existence of important information and often do not have the tools available to thoroughly explore relevant relationships and trend indicators.

Also, external information or data, even when categorized, is often not at a level of granularity sufficient to be of value in determining appropriate causes and effects. Numerous service bureaus compile and sell historical information and analyses. However, the available historical information tends to be at a macro level such as by metropolitan area or by industry. For example, if unemployment rises in the Pacific Northwest, it is extremely difficult to determine from industry sources what the risk exposure would be for the aerospace, computer software and logging industries in that specific region because standard format reports are unable to slice and dice the information down to the desired level of granularity without becoming extremely cumbersome to use, or reducing the information to a meaningless sample size.

Information sources provide vast amounts of information that is readily available and can be used by decision makers to promote intelligent decision-making. However, this information is largely unstructured, and thus, although it is available, it cannot be analyzed and organized in a convenient manner. For example, conventional search tools such as search engines can be used to find and filter some information. However, for many purposes, typical search engines provide unsatisfactory performance. Typical search engines return results to queries based upon internal representations of data derived from previously analyzed Websites. However, these internal representations of data are based upon the words contained within such previously analyzed Internet sites, and are not a measure of the content described thereby. Also, typical search engines only query static information on Websites, and are unable to input search terms that would enable deeper exploration into the Website's archives.

There are numerous other limitations with conventional searching tools such as search engines. For example, search engines are incapable of filtering relevant information from irrelevant information. Also, due in large part to the expansive nature of the Internet, search engines often possess a limited ability to update and revise their internal representations of data, and are thus of marginal value in keeping track of Internet sites containing dynamic and constantly varying information. Still further, typical search engines are subject to the limitations of the user performing the search. A user's mastery of querying for data will largely drive the likelihood of a successful search within the search engine limitations described above.

### SUMMARY OF THE INVENTION

The present invention overcomes the disadvantages of previously known information systems by providing systems and methods for analyzing information by harvesting data and using the harvested data to predict results, populate predictive models, make decisions, and allow decisions to be made.

According to one embodiment of the present invention, a method of analyzing information includes harvesting and analyzing data to populate predictive models (including previously established models) that may be used to identify previously unknown relationships such as trends or patterns between data of interest and the harvested data.

For example, data from one or more data sets is separated into one of a behavioral item category, an external key item category, and a “neither of the above” item category. The data sets may include for example, internal business data stored in one or more databases. Data previously separated into the behavioral item category is analyzed to identify and group those data items having similar behavioral patterns or signatures. One of the groups is selected for analysis and an event of interest that affects the group of interest is identified. Candidate external keys that relate to the data in the selected group are also identified from the external key category or from other sources.

Additional data is then harvested using one or more of the candidate external keys. Harvested data will generally include largely unstructured external data, but may include any combination of internal and external data, as well as any combination of structured and unstructured data. The harvested data is analyzed using any number of statistical measures. For example, the harvested data can be analyzed to determine whether one or more correlations exist between the harvested data and the group of interest. The correlation(s) may identify factors such as external events that drive the event of interest identified for the group of interest. The correlations may be used to construct a predictive model, which may then be used to establish a watch event. Upon recognition of the watch event, a predetermined response is generated thereto.

According to another embodiment of the present invention, a predictive model is generated from available data such as internal structured data. Additional data is then harvested using for example, candidate external keys derived from the available data or readily available from other data sources. The results of the harvest are then analyzed to ascertain the ability of the harvested information to improve the previously derived predictive model. For example, the harvested information may provide correlations that strengthen or weaken the predictive model. Also, the harvested data itself may contain viable external keys that may be used to harvest additional information. As such, harvested data can be used to substantiate, explain, or refute trends, patterns, and other predictive results in internal data. The harvested data can also be used to create content and find correlations where none previously exist in the initial predictive model.

In addition to finding answers to internal results based upon external data, and improving or otherwise modifying predictive models, the present invention may also be used to run and evaluate predictive models, and to run “what-if” types of analysis and simulations to test the effects of changing operational parameters.

Accordingly, it is an object of the present invention to provide systems and methods for analyzing information by harvesting data and utilizing the harvested data to predict results, populate predictive models, make decisions, and allow decisions to be made.

Other objects of the present invention will be apparent in light of the description of the invention embodied herein.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is a flow chart of a method for performing information analysis according to one embodiment of the present invention;

FIG. 2 is a flow chart of a method for implementing a setup step according to one embodiment of the present invention;

FIG. 3 is a block diagram of a system for implementing a setup step according to one embodiment of the present invention;

FIG. 4 is a flow chart of a method for defining signatures according to one embodiment of the present invention;

FIG. 5 is a flow chart for a method of harvesting data according to one embodiment of the present invention;

FIG. 6 is a schematic illustration of one system for harvesting data according to one embodiment of the present invention;

FIG. 7 is a block diagram of a system and method for harvesting data according to one embodiment of the present invention;

FIG. 8 is a flow chart of a method for predicting results and monitoring data sources for predictive indicators according to one embodiment of the present invention;

FIG. 9 is a block diagram of a method for performing information analysis according to another embodiment of the present invention; and,

FIG. 10 is a flow chart of a method for performing information analysis according to another embodiment of the present invention.

### DETAILED DESCRIPTION OF THE PREFERRED EMBODIMENTS

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that logical changes may be made without departing from the spirit and scope of the present invention.

As used herein, the term “unstructured data” is to be interpreted to encompass generally any data that is not confined to a predefined structure. Unstructured data can include for example, text and word processing documents, numeric information and other data stored in spreadsheets, flat files, digital audio data, video, graphics, images, html pages, websites, categorical data, and other digital representations that have no defined structure. Unstructured data can be found in any number of diverse locations. For example, unstructured data includes web pages and html code found across the Internet, extranets, and other networks, various word processing documents, spreadsheets, emails, threads in newsgroups, and other electronic files commonly found stored on typical computer network systems, and other digital information found in electronic subscription services and electronic bulletin boards. The definition of unstructured data also extends to data that is owned by others, and therefore not in a format which is under local control, even though the storage format is structured.

As used herein, structured data is data confined to a predefined data structure such as data that is stored in a database as conventionally understood in the art, and whose format is controlled by the user, or defined in a published sense by an external party. For example, a database organizes data according to a predefined structure, such as by rows of records having predefined columns of attributes (fields) of data for each record. For data to be a valid attribute for a given record, that data must comply with the specification, requirements, definition, or parameters of the attribute. For example, typical databases include records stored as rows of an array. Associated with each record are one or more attributes (fields) of data that contain information pertinent to the record. The attributes usually comprise alphanumeric strings, date information, logical information, and numeric information.

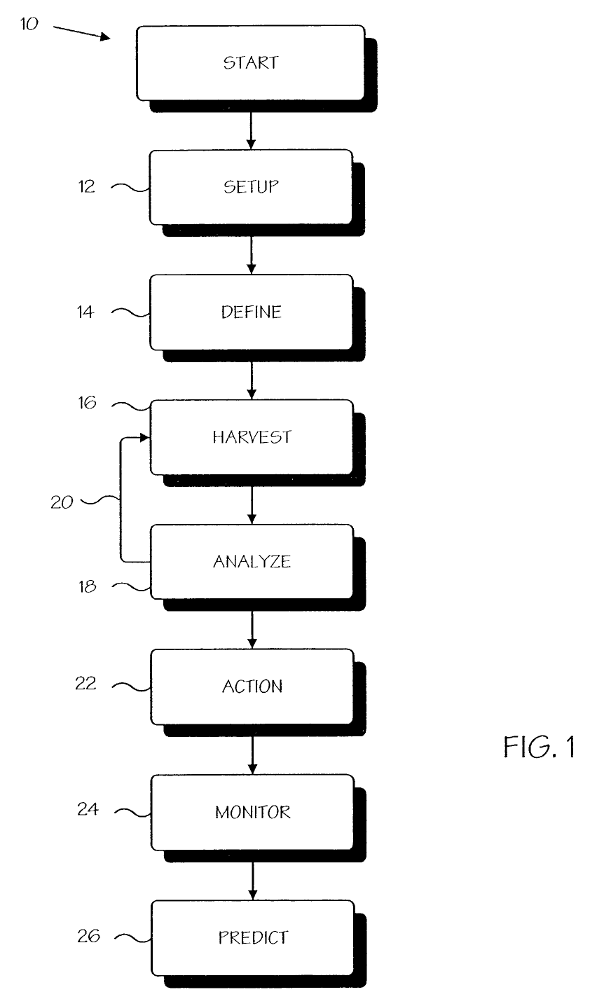

Referring initially to FIG. 1, a method 10 of performing information analysis according to one embodiment of the present invention is illustrated. Initially, data from one or more data sets is set up at step 12. A data set may comprise for example, data from an internal source (or sources) such as structured data stored in a database. The set up at step 12 categorizes the internal data to be analyzed in an appropriate manner. An initial analysis of the internal data is then performed at step 14. The analysis at step 14 organizes the data set up at step 12 to define one or more meaningful groups or signatures. Each group is thus made up of a subset of the data set up at step 12. The groups or signatures may also include hypothetical data for processing “what-if” types of scenarios. The analysis in step 14 may be used to define certain parameters for performing information analysis. Specifically, at least one group of interest is selected for which data analysis is required. Also, an event of interest may optionally be tagged. The event of interest is used to further identify the inquiry with respect to the data set up at step 12. The event of interest can be derived from or relate to actual available data or the event of interest can be hypothetical, for example, to process “what-if” scenarios.

A harvesting of data is then carried out at step 16. The harvesting at step 16 will generally include largely unstructured external data, but may include any combination of internal and external data, as well as any combination of structured and unstructured data. An analysis of the harvested data is carried out at step 18. For example, the analysis at step 18 may be used to explore whether correlations can be determined between the data previously harvested and the selected group defined at step 14. The correlations may then be used to test, build, refute, validate, or otherwise analyze predictive models. Other statistical measures and processing may also be explored in addition to, or in lieu of, the above described correlation analysis. For example, the analysis at step 18 can be used to create or derive content, explore the relevance of relationships, and explore trends and patterns in the available data.

Harvesting and analyzing at steps 16 and 18 can be optionally recursively carried out as identified by the feedback loop 20, until a stopping event occurs. For example, the recursive harvesting can continue until a clear correlation is established. Also, a “time-out” may be used to prevent a perpetual recursive harvesting where time is limited, where a limited number of iterations are to be explored, or where it becomes clear that a useful correlation is not developing. A stopping event may also be triggered by human intervention arranged to stop the recursive harvesting and analyzing steps.

The results of the analysis established by harvesting and analyzing external data at steps 16 and 18 provides information from which an action can be carried out at step 22 in response to the results of the previously performed analysis. For example, the action may include optionally establishing a trigger event for proactively monitoring data sources at step 24. The trigger event enables predictions to be made about internal data from the perspective of external (often real-world) events at step 26. For example, once a watch event has been established, sources of data are monitored at step 24 for an occurrence or suggestion of the watch event. Detection of a watch event triggers an appropriately assigned response to that event at step 26. The action at step 22 may also include triggering workflow and generating reports that advise of courses of action or present results of correlations.

Accordingly, one aspect of the method 10 is the ability to predict results across a variety of applications based generally upon largely unstructured external data. As such, the method 10 can be implemented for a variety of tasks including, for example, developing context where there is none, finding answers, as opposed to just finding data, to questions unanswerable from internal data alone, and for exploratory “what-if” data analysis.

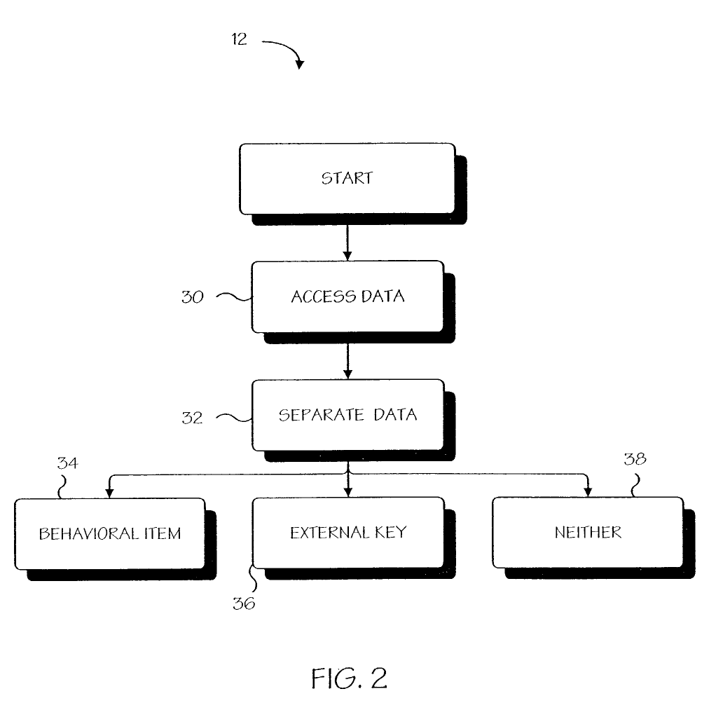

The setup performed at step 12 according to one embodiment of the present invention is illustrated FIGS. 2. Initially, one or more data sets comprising for example, structured, internal data are accessed at step 30. The internal data is separated into categories at step 32 based upon a desired use for a particular piece of information. For example, as illustrated, internal data is broken down into three categories including a behavioral items category 34, an external keys category 36, and a “neither of the above” category 38.

Data that is categorized in the behavioral items category includes data that describes standard internal measurements or otherwise provides information where some data analysis is likely to be of interest. For example, for a business such as a financial institution, the behavioral items category 34 may contain data such as customer payment performance or credit scores. Likewise, for a manufacturer, data categorized in the behavioral items category 34 may include a customer purchase history, customer returns history, or supplier performance.

Data that is categorized in the external key items category 36 includes data that may be useful for harvesting. That is, an external key item can be any information that may assist in locating useful information from any number of diverse sources such as internal structured data not previously considered, internal unstructured data, external structured data, and external unstructured data. External key items can include for example, demographic data such as age or gender, geographic data such as city, state, or ZIP code, occupation or industry, SIC codes, or employer. Data that is categorized in the “neither of the above” category includes data that is relevant neither as a behavioral item nor an external key item. For example, a neither of the above item may include spouse's name, children's names, etc.

The categorization of a particular type of information at step 32 is contextual and, as such, no definitive and conclusive categorization may be realized for a particular type of data across applications. For example, in one application, date of birth may be important for data analysis and thus may be categorized as a behavioral item. In another application, date of birth may be of absolutely no consideration to an analysis and may be categorized as a neither of the above item. In still a third application, date of birth may be considered an external key used for harvesting.

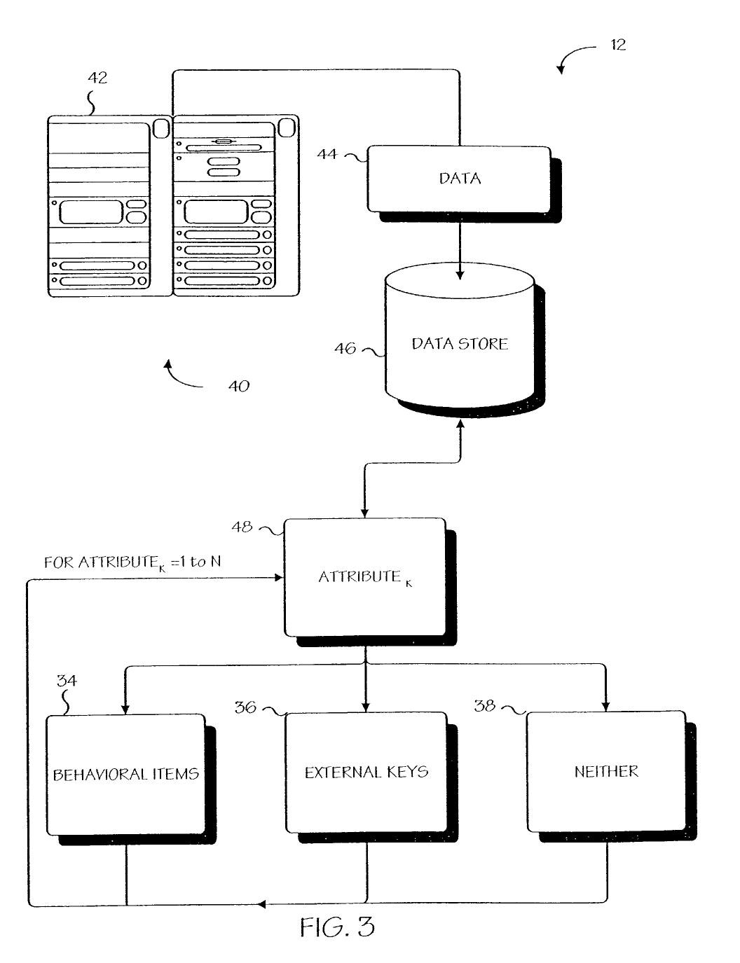

Referring to FIG. 3, the setup step 12 according to one embodiment of the present invention is implemented using a computer system 40. A computer 42 loads data 44, such as structured internal data from one or more databases 44 into a common data store 46 within a storage device. For each record (row) in the database 44, the internal data is separated by attribute (column) 48 into a select one of the behavioral items category 34, the external keys category 36, and the “neither of the above” category 38. This process repeats for each database of interest until the attributes for all the appropriate internal structured data has been categorized.

A number of approaches can be used to accomplish the categorization of the databases 44. The exact manner in which the appropriate attribute 48 will be assigned will depend upon the selected manner in which the data will be identified and saved. Also, the data may require extraction or other transformations to ensure the data is in an appropriate format for analysis. Accordingly, conversions, such as data stream sequencing, missing data imputation, sampling, and data transformations may be required to prepare the data for analysis.

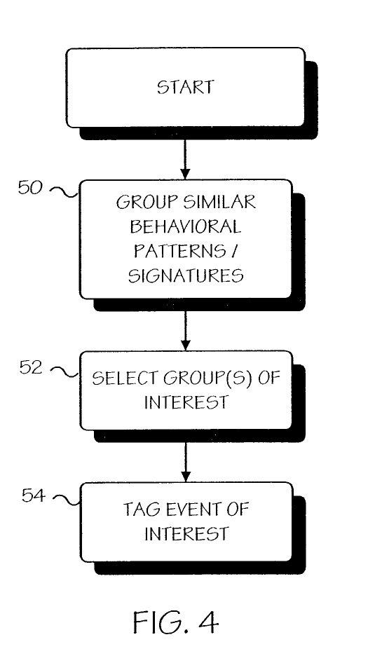

Referring back to FIG. 1, after the internal structured data has been appropriately categorized, such as by the setup at step 12, the data is organized and analyzed at step 14. The organization and analysis in step 14 may be implemented according to one embodiment of the present invention as illustrated in FIG. 4. Initially, the internal structured data is grouped into one or more meaningful relationships or signatures at step 50. For example, data previously separated into the behavioral item category is analyzed to identify and group those data items having similar behavioral patterns or signatures. The behavioral patterns may be based upon any criteria including for example, a signature, item, variable of interest, related event, or pattern as measured over time. The groups can also be used to capture the essence of large disparate datasets, models, or simulations such that the use of the signatures to conduct analysis is a suitable surrogate.

Once the relationships between data items have been established and the groups identified at step 50, it may be desirable to focus further on one or more of the relationships or groups. Accordingly, a select one or more of the groups derived at step 50 is selected at step 52. Next, an event of interest is tagged at step 54. The event of interest tagged at step 54 defines an area of interest in which data exploration or analysis is required. The event of interest should preferably affect at least a percentage of the group(s) of interest selected at step 52.

According to one embodiment of the present invention, the method 10 can be used to run and test “what if” types of scenarios. Under this arrangement, the groups may not be based upon actual data separated into the behavioral items category. Instead, a selected group may be synthesized from hypothetical or otherwise fabricated information.

Referring back to FIG. 1, once a selected group is identified and the event of interest has been tagged, data is harvested at step 16. The harvesting of data seeks to assemble data that pertains to the selected group of interest, and optionally, to the event of interest. This does not mean that all data harvested will eventually prove to be relevant to the information analysis or to the selected group of interest for that matter. Rather, the harvesting of data is, at least initially, directed by the external keys, which themselves relate in some manner to the group of interest.

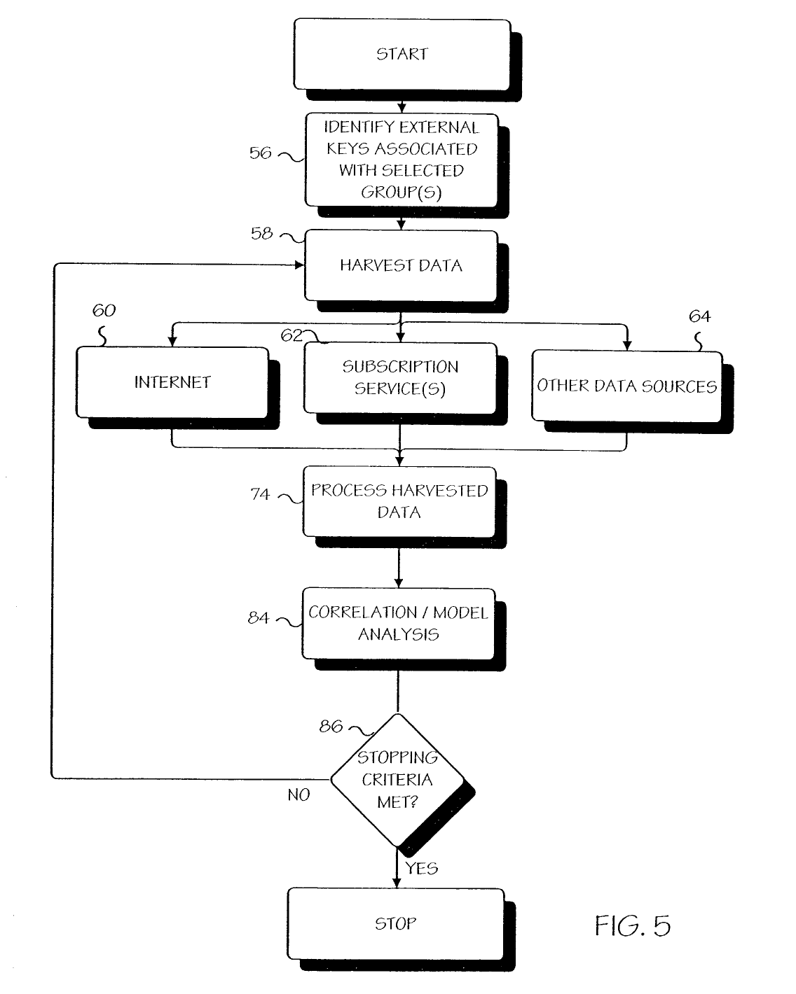

Referring to FIG. 5, a method of harvesting data according to one embodiment of the present invention is illustrated. Initially, candidate external keys that relate to the data in the selected group are identified at step 56. Based on the external keys associated with the selected group(s), harvesting of data is performed at step 58. Harvested data can include any combination of structured and unstructured data obtained from internal or external sources. For example, data may be harvested from the Internet 60 including the World Wide Web, from various subscription services 62, and from other data sources 64. Other data sources 64 may include internal sources such as company intranets, extranets, and other resources where source information is stored. For example, unstructured internal information such as information from internal company knowledge management systems and customer complaint information systems may be harvested. Also, structured internal information not previously considered may be harvested. Other data sources 64 may also include external sources such as electronic bulletin boards and newsgroups.

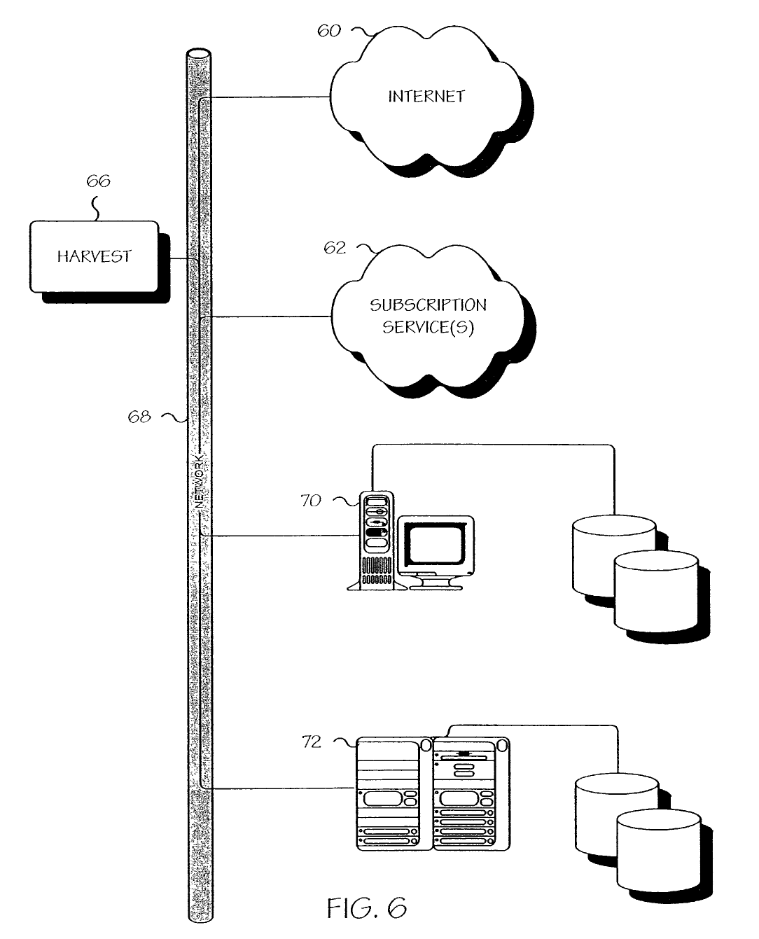

Referring to FIG. 6, the harvesting of data according to one embodiment of the present invention may be accomplished using a harvester. The harvester 66 utilizes computer network 68 to access any number and types of data sources. For example, the harvester 66 may search through the volumes of data on the Internet 60, subscription services 62 or other data sources including servers 70 such as file servers that store largely unstructured data sources including text documents, html pages, and emails as found on typical business local area networks, and on data servers 72 that store large amounts of structured data such as enterprise resource planning systems, customer resource management systems, call center systems, relational database management systems, and other database systems. The servers 70 and data servers 72 may be either internal or external sources.

As used herein, a harvester is a software component that is programmed to collect information from data sources and repositories. Harvesters can operate in a manual, semi-automated, or a completely automated fashion. Examples of typical harvesters include various forms of web-based robots, spiders, crawlers, and agents. However, the harvester of the present invention is not limited thereto.

For example, harvesters can automatically collect information from data repositories following a pre-specified set of directives. In such cases, the directives may include, for example, instructions to the harvester to follow URL links embedded in Web pages to collect data. Harvesters can return the entire HTML page collected or perform a scraping operation thus returning only a subset of the information visited. Harvesters can also be used to submit pre-specified information to web forms in order to retrieve information. For example, a search term like a zip code can be given to the United States Postal Service web site to harvest a page that contains zip code to U.S. city matches. Likewise, harvesters can drive deep into Website archives to collect information.

Referring back to FIG. 5, the methods and processes used to implement the harvesting of data in step 58 can vary in scope and complexity from simple spiders that merely fetch and return data, to more sophisticated components capable of handling not only external data source access, but that further supervises the monitoring and retrieval of such information. For example, a harvester may accept requests to harvest data from other components or processes. Such requests may be for specific data, or for data in general. The harvester may further process such requests against information accessible to the harvester concerning data sources and harvesting approaches. Based upon available information, the harvester then accesses and retrieves external data, and can provide status information to the requesting component about ongoing processes and results of the harvest.

For example, the harvester can load, read, and use metadata to respond to requests and drive the harvests. The harvester may also monitor visited sites, for example, to ensure that the sites still exist, and to determine if data has changed. The harvester may also output information to requesting system components, processes, files or databases. Further, harvester data may be output to local archives to serve as a proxy or cache. The harvester may optionally work with undefined and unbounded data sets and is capable of developing content where none exists.

The data returned from the harvesting performed in step 58 is processed at step 74. According to one embodiment of the present invention, the harvested data is analyzed and a signature is created. The signature is then added to the data previously collected at the setup step 12 discussed with reference to FIGS. 1-3, and is analyzed against previously obtained data.

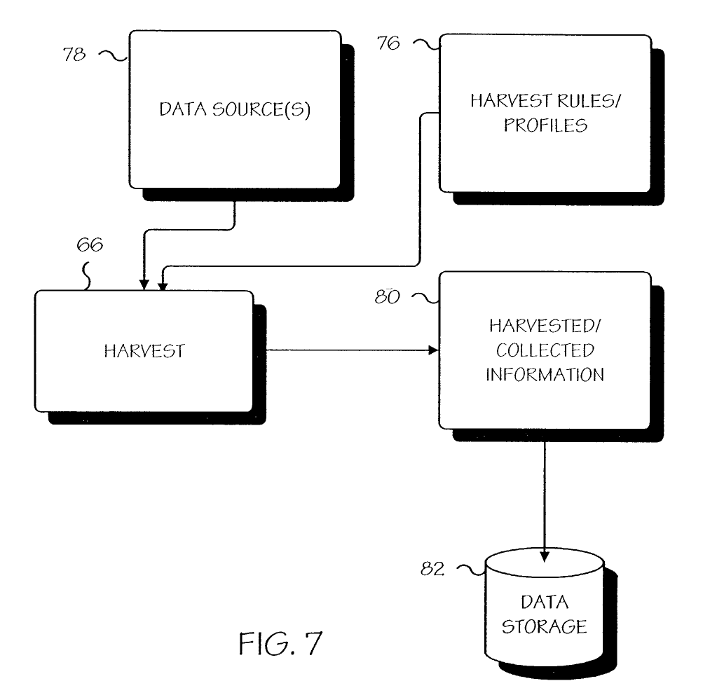

According to one embodiment of the present invention, highly dynamic content is optionally gathered and assimilated, without the need to perform time-consuming clean, format and store functions. Analysis of external information may also require the ability to create a “signature” of the harvested text, which can be used for further analysis and for predictive purposes. Referring to FIG. 7, a system and method for storing harvested information according to one embodiment of the present invention is illustrated. A harvester 66 optionally utilizes directives 76 such as rules, profiles, instructions, directions, templates, input parameters, or other guidance to harvest data from data sources 78 such as the Internet, subscription sources, electronic bulletin boards, news groups, and other data sources.

The harvested data 80 may then be linked to other existing data in a data store 82. The data store 82 thus stores all relevant data, irrespective of whether the data is derived from internal or external sources, and irrespective of whether the data is unstructured or structured. For example, the harvested data 80 may be added to existing data such that both unstructured data and structured data are linked in a manner without a predefined data format. Further, the present invention preferably links harvested data such that no time-consuming data warehouse and data integration procedures such as file extraction, structuring and cleansing is required.

According to one embodiment of the present invention, one general objective of harvesting is to seek data that allows the derivation of correlations to explain what a selected group has in common from an external standpoint. As such, the harvesting of data in step 58 is preferably carried out in an intelligent manner to explain the tagged event of interest as it relates to the selected group identified in step 14 of FIG. 1 based upon external events. For example, the harvested data can be analyzed to determine whether a correlation exists between the harvested data and the selected group. The correlation may identify factors such as external events that drive the event of interest identified for the selected group. The correlation(s) can then be used to build and test predictive models for performing information analysis.

For example, a business may want to know whether there is external information about markets or customers that, if captured and analyzed, would mitigate default or repayment risk. To respond appropriately, data may be harvested that is pertinent to external events that may explain a potential for risk. Exemplary information may include data referring or relating to local economic information, competitor activity, layoff news, bankruptcy filings, deaths, births or divorces, unemployment compensation filings, or credit bureau database information. To obtain such information, the harvesting at step 58 can search structured data sources as well as unstructured data. It is likely, however, that a substantial portion of the data searched will be unstructured data such as media reports, newspapers, web pages, and industry specific portals. Further, this data can be established from external sources defining events at the individual account or portfolio level, community or corporate level, national or international level.

The manner in which data sources are selected for harvesting at step 58 will likely vary from application to application. For example, it may be suitable to use predetermined query structures. However, predetermined query structures may only be effective on predefined and bounded data sets. According to one embodiment of the present invention, query structures used for harvesting data are dynamic in the sense that the harvesting is carried out using queries that are suggested (data driven), and collected/expanded (query driven). As such, the dynamic query approach can search undefined and unbounded datasets and develop context where there is none. The harvesting of relevant information takes cues from the external keys identified at step 56 of FIG. 5 that are associated with the selected group identified at step 14 of FIG. 1.

Referring to FIG. 5, the ability of the harvesting at step 58 to provide relevant data of the best possible content will thus be dependent at least in part based upon the harvester being provided adequate query terms for harvesting in the form of external keys. Further, the ability of the harvester is at least partially dependent upon the adequacy of proper query formulation on the information to be retrieved.

The harvested data is analyzed at step 84 to determine if specific data, external functions, external sequences, or combination of external events correlates with the selected group that would explain the event of interest. The analysis may be carried out for example, by creating a mathematical signature of the harvested data and testing for correlations with the internal data of the selected group.

For example, a financial institution may want to find correlations between prior business performance such as payment defaults, and a specific group of customers. Under this scenario, the harvesting at step 58 may return unstructured external information such as news agency and other media reports of employment layoffs. The correlation being developed at step 84 may seek to answer, for example, whether the external aspect being considered (layoffs) explains the event of interest (payment default). That is, the correlation will seek to explain whether an occurrence of the external event under consideration makes the event of interest with respect to the selected group, any more probable.

A computation is thus made to determine whether news of layoffs increases the probability of late payment from the customers of interest in the selected group. To make such a determination, a mathematical signature of the external unstructured data is derived and statistical correlations to the internal data are tested. If a correlation is established, the general concept of harvesting information of layoffs may be implemented generally. For example, the harvester may look for articles of layoffs in other geographic areas and industries and compare the located information to the currently selected group, or other groups of data identified at the setup step 12 discussed with respect to FIG. 1. This generalization may also be extracted across multiple data sets.

The correlations can be computed, for example, using best-in-breed analytic software or techniques, or may determined using proprietary approaches. For example, an analysis may look for distinguishable events through trend and anomaly detection, multi-query comparison, analysis of threads, web harvesting and characterization, and queries of long documents. Also, preferably, the harvesting of data in step 58 is carried out in an intelligent manner that screens or eliminates irrelevant data that does not affect any correlations that may be examined. According to one embodiment of the present invention, links and relationships are revealed without any prior knowledge of such external events. Rather, external data is harvested without any prior assumptions.

The correlation capability is heavily statistical in nature, thus results will depend upon the manner in which the statistics are implemented. The manner in which the data is analyzed will depend, in part, upon the type and amount of data collected. For example, unusual behaviors in large sets of multivariate data may require more sophisticated mathematics and statistics to locate correlations than a more simple and obvious case. Examples of statistical approaches may include the calculation of an atypicality score to find anomalous data or multi-rate relevance clustering. Also, correlations are only exemplary of the statistical analysis that may be carried out. For example, predictive models may be constructed, trend and pattern analysis may be explored, and content may be created to associate internal signatures to signatures of external events.

In determining whether a correlation can be established between external events and a selected group, the correlation may not be meaningful unless preliminary data preparation is performed. For example, it may be desirable or required to transform values within representations such as performing missing data imputation, scaling, normalizing, or unit conversion. Other techniques such as clustering, and dimensionality reduction may also be required.

Irrespective of whether the harvested data is structured or unstructured, there remains the issue of determining which data, events, and indicators (if any) will improve the correlation or other analysis. Instead of trying to “replace” a trained analyst with domain expertise with a piece of software in every instance, the construction of a correlation or other predictive model according to one embodiment of the present invention uses an iterative approach, leveraging the harvesting and analytic components to adaptively build relationships between internal results and external driving events. Based on correlation between the two, a set of “contextual needs” can be established which link external trends to internal business requirements.

Other additional processing techniques may also optionally be used to enhance correlation determination. For example, a correlation ordering on the data signatures may be performed to assist in presentation of the data to the end user. Correlation metrics may also be developed to determine relationships among clusters created during processing using different attributes of the data.

Harvesting can be carried out as a one-time query, or continually or periodically. The harvesting of data may continue to recursively search for data in order to refine and improve search results. For example, the harvested data itself may contain additional keys that can be used to yield further harvesting and analysis. The recursive or reiterative process repeats until a predetermined stopping criterion is met at step 86. For example, a stopping event may comprise a clear correlation between a signature and a set of external events, or the harvesting “times out” either in processing time or number of iterations without finding any suitable correlation, or it may become clear that no correlation or other predictive model can be developed. Still further, operator intervention can trigger a stopping event.

For example, a user can identify key sites or default paths for harvesting data. The harvester can then automatically reiterate, branching out from there. The harvested data itself may contain keys such as links to additional external data sources. Accordingly, the harvester iterates to the next source of information and threading develops to discern appropriate context. This recursive approach to harvesting may also be implemented to achieve intelligent refinement of directions through multiple iterations by analyzing full, unfiltered data sets.

Through iteration, new relationships may be added, and hypothesis correlations may be developed, tested and refined. For example, recursive harvesting may be used to build a thread to try to get to a point where a correlation exists. Also, a positive correlation in one area, and a negative correlation in another can be used to refine results, and determine what is the best source of a hypothesis correlation. Recursive harvesting also gives a check on the quality of the correlation indicator. For example, additional relevant data may be harvested which either substantiates or refutes a hypothesis correlation.

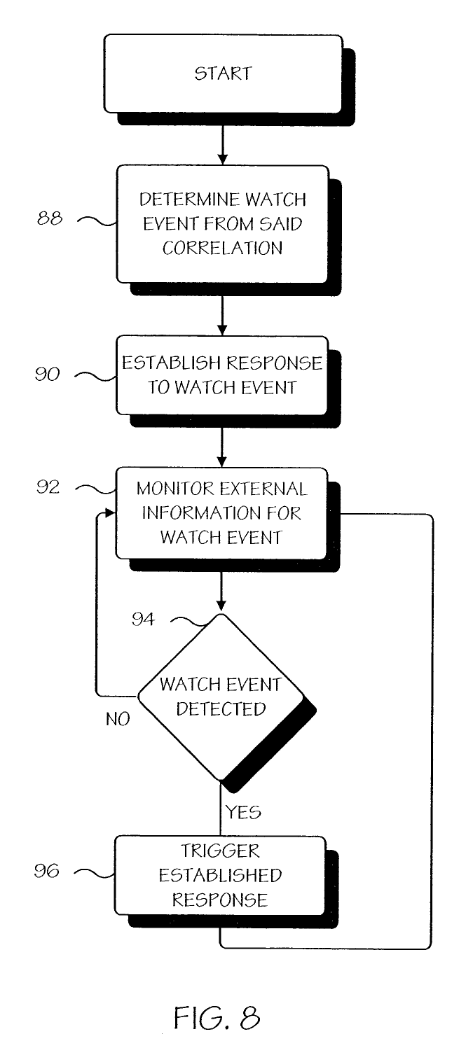

Referring back to FIG. 1, established correlation(s) or other computed statistical measures can be used to perform monitoring and predictive functions as indicated at steps 24 and 26. Referring to FIG. 8, a method of monitoring and making predictions based upon an established correlation according to one embodiment of the present invention is illustrated. Once a correlation has been established, a trigger or “watch event” is devised that indicates, for example, specific behavior within a given signature at step 88. This allows external events to become managed. The watch event is generally an occurrence of an event in which it is likely that some action may be required. Accordingly, an appropriate response or range of responses is established at step 90.

The watch event allows management of overall business policies and allows specific strategies to be defined that should be implemented based on predicted and future occurrences of these external events. A given response to this event can be established by the business at a strategic, portfolio or operational level. For example, triggering a response can comprise any combination of automated and manual activity. Further, a suitable response may be effected entirely by computer automated actions, by human actions, or a combination of computer activities and human activities. For example, a suitable response may be for a computer system to send an alert to a human operator. The operator or computer may then send out letters, emails or other types of internal alerts, external correspondence, or other form of communication. As another example, a triggered response may be for a computer to set a flag and leave it to the business to decide how to respond. Further, an appropriate response may be to integrate into the business workflow a predetermined course of action, such as to communicate with customers or to change marketing strategies with or without human intervention. The computer can also be used to advise an operator of options or a range of options based upon the detected event. As such, the action of the computer is more than merely outputting raw computational results of the statistical computations. Rather, the output is either a direct action on the part of the computer system, or alternatively, the computer advises or presents information to an operator in such a manner that an operator is capable of making a decision or taking an action.

Once a watch event has been established at step 88 and a response has been determined at step 90, external information is monitored at step 92. The external data may be monitored continuously, or periodically, as the application dictates for repetition of the watch event. Further, monitoring predetermined external sources may lead to harvesting additional data in possibly new data locations. If a watch event is detected at step 94, the response established at step 90 is triggered at step 96.

As an example, a financial business may find a correlation between the weather in a specific geographic region such as a farming community and late payments received by customers living in that geographic region. A watch event may be set up to monitor the weather of that region, at least during the farming season and if a bad farming season is detected, trigger response to either automatically, or through other manual channels, offer those customers deferred payment or reduced payment options. The above functions can be extracted to a general application applied to all of the groups, or applied across multiple data sets. For example, once a correlation is established linking bad weather to farmers in one geographic area, the weather in other geographic areas may also be monitored for those similar signatures. As yet another example, a detected event such as a layoff at-a company may trigger a policy to offer a deferred or reduced payment option to those clients who are laid off.

The method of performing information analysis according to one embodiment of the present invention may be implemented as a software solution executable by a computer, or provided as software code for execution by a processor on a general-purpose computer. As software or computer code, the embodiments of the present invention may be stored on any computer readable fixed storage medium, and can also be distributed on any computer readable carrier, or portable media including disks, drives, optical devices, tapes, and compact disks.

Referring back to FIG. 1, it may be desirable in some instances to allow the method 10 to continually update even after correlations or predictive models have been established. For example, the development of meaningful correlations or other predictive models often involves more than rule-based intelligence, but rather, human insight that is extremely hard to analyze and codify. For example, the generalization of a correlation may be difficult to implement depending upon the signatures and data being harvested.

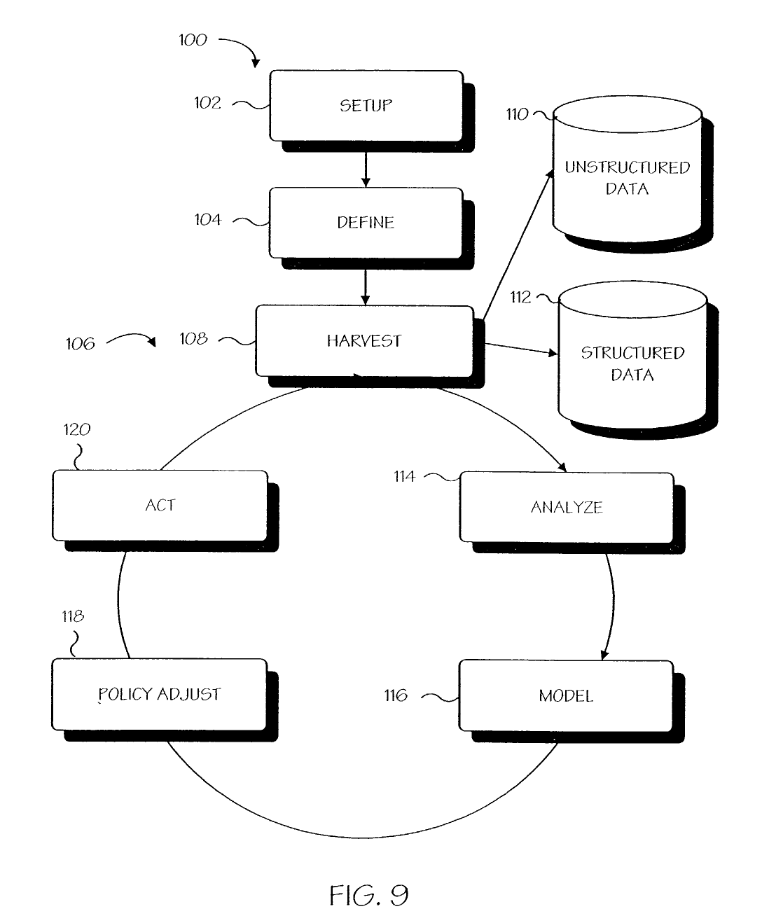

Referring to FIG. 9, a method 100 of performing data analysis is implemented as a discovery cycle. Internal structured data is set up at step 102. Signatures and at least one event of interest are defined at step 104. A discovery cycle 106 is then entered. External data is harvested at step 108 including unstructured data 110 and structured data 112. The harvested data is analyzed at step 114 to determine whether a correlation or other predictive model can be determined at step 116. As a model is developed and refined, watch events are established and policy adjustments are made in response thereto at step 118. Detection of a watch event triggers the appropriately devised act at step 120. The discovery cycle 106 continues to loop and refine the developed models, watch events and acts developed in response thereto.

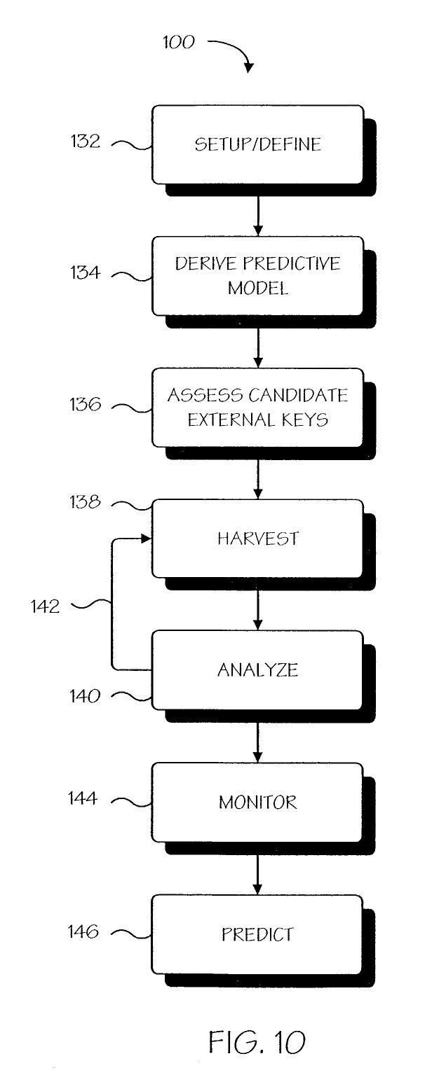

Referring to FIG. 10, a method 130 of performing information analysis according to another embodiment of the present invention is illustrated. Initially, internal data is set up at step 132. The setup at step 132 is an optional step and may be used to identify important internal data, further categorize internal data, and transform or otherwise preprocess internal information. For example, internal data may be organized into signatures of interest. The internal data is used to deliver an initial predictive model at step 134. The initial predictive model can be derived using either previously established enterprise models or models developed specifically in response to an event of interest.

Candidate external keys are derived from the internal data and from any other available sources at step 136. Harvesting of information based upon the candidate external keys or other defined information is performed at step 138 and the results of the harvest are analyzed at step 140. According to one embodiment of the present invention, the predictive model is used to direct the harvesting. For example, the imprecision in the predictive model drives a signature that the harvesting at step 140 attempts to clarify or resolve.

The analysis at step 140 ascertains the ability of the harvested information to improve the previously derived predictive model. For example, the harvested information may provide correlations that strengthen or weaken the predictive model. Also, the harvested data itself may contain viable external keys that may be used to harvest additional data. Accordingly, a feedback path 142 allows the harvesting at step 140 and the analysis of harvested information at step 142 to recursively run until a predetermined stopping criterion is established. As one example, recursive harvesting of data is carried out. The harvested data is analyzed in terms of relevancy to the external keys and in terms of the relative frequency of themes in the harvested data that are relevant to the external keys. The analysis further assesses the potential of the harvested data to further improve the predictive model. As such, external harvested data can be used to substantiate, explain, or refute trends, patterns, and other predictive results in internal data. The harvested data can also be used to create content and find correlations where none previously exist in the initial predictive model.

Based upon the established predictive model, events, including internal and external events can be monitored at step 144 and predictions are made at step 146 based upon the monitored information in view of the predictive model. Any necessary actions may then be either manually of automatically driven. Also, continued monitoring of events, either internal or external, may be used to continually drive and improve the predictive model such that the model becomes adaptive.

The harvesting and analysis of the present invention allows for dynamic categorization of information enabling a user to identify the cause of specific trends by steering the analysis toward a conclusive explanation of effects. Dynamic categorization can occur in both a bottom up and top down mode. A bottom up example may indicate similarity in trends between major cities such as San Diego and Boston. In this example, the present invention is used to analyze external unstructured information, which may point to significant industry activity in a subset of the biotechnology field specific to those locations, and furthermore not present in other major locations. A top down approach would be the opposite—the determination of activities in a biotechnology field being driven down to specific locations or companies. The power of the present invention in collecting, correlating and steering unstructured analysis is in the dynamics of combining the huge amounts of unstructured data to identify the true causes of highly granular results.

The steering of unstructured information harvesting to determine highly granular causes and effects introduces a significant new set of capabilities which can be applied to business intelligence and analytic functions across a broad range of applications. Previous business capabilities, processes and applications have tended to focus on well contained functions internal to business operations, for example manufacturing capacity planning or order processing. More recent focus on areas such as supply chain, demand chain and customer relationship management have continued to be from an internally driven view. The capabilities of the present invention according to at least one embodiment represent an externally driven view of cause and effect and can therefore be applied wherever the condition, events, trends, capabilities, capacity or dynamics of the external environment impacts business functions, responsiveness or results. The following paragraphs illustrate a few exemplary applications of the present invention.

Financial Risk Analysis

Lending institutions frequently evaluate the credit worthiness of customers prior to making a loan. However, U.S. banks and savings institutions incurred net charge offs in the amount of approximately $38.8 billion dollars, of which $21 billion was consumer-related in the year 2001. This represents nearly a 50% increase over the year 2000 loss level of $26.3 billion. A major cause of such write-offs is the result of changes in customer financial profiles subsequent to the initial credit worthiness screening, some of which is caused by external factors such as the economy, employment trends, etc.

Referring to FIG. 1, the method 10 according to one embodiment of the present invention can be used to carry out risk assessment. Customer data is selected at step 12, and customers with similar behavioral patterns or “signatures” are grouped against time at step 14. For example, this may include a grouping of all customers who have stopped making payments, or customers who chronically fall behind, then catch up in making their scheduled payments. A particular group is then selected for analysis and an event of interest is optionally tagged. The event of interest seeks to gain a better understanding with regard to the identified behavior of the selected group. In the above example, an event of interest such as payment default is tagged. Data is harvested at step 16, and the results of the harvested data are analyzed at step 18.

The harvesting of data is steered towards deriving correlations that identify factors from external events that drive the event of interest identified for the selected group. For example, the harvesting may uncover information about major job layoffs, bankruptcy filings, or other economic indicators that affect one or more of the selected customers. Based upon the analysis of the harvested information, an action is carried out at step 22 to update a measure of financial risk. Determining more granular risk profiles (e.g. by attribute such as industry, employer, job type, length of employment etc.) can significantly reduce risk profiles and enable a more stable risk portfolio to be built over time. Other actions may also be triggered, such as offering financial planning options such as deferred payments, hardship allowances, and other responsive actions to those customers affected.

Insurance Risk Analysis

The Property and Casualty insurance sector (including workers' compensation) had a negative return of approximately $7.9 billion in the year 2001, as falling investment income was unable to overcome a sharp rise in underwriting losses. Loss payouts of approximately $276 billion amounted to about 88.4% of premium income. With operating costs added in, the industry's underwriting loss amounted to $53 billion. One reason such losses exist is because business decision makers are making underwriting and other business decisions with incomplete data. Further, their underwriting practices are highly reactive and incorporate little to no prediction of future trends.

The above exemplary risk assessment method can also be extended to risk assessment pertinent to the insurance industry. Under this arrangement, customer data such as insurance policyholder data is selected and grouped at steps 12 and 14 as described above. Data is then harvested at step 16 and analyzed at step 18 to determine whether correlations can be established that describe what a selected group of customers has in common from an external standpoint. The analysis at step 18 can include for example, exploration of granular trends and impacts of weather related events, including loss forecasting associated with floods, hurricanes and earthquakes. The results of the analysis are then used to update measures of risk exposure at step 22. For example, the action at step 22 can include identifying markets that pose a high-risk exposure, directing a modification to premiums as a result of the updated risk exposure measure, and suggesting new markets where risk exposure is minimized or where coverage is in demand.

In addition, coverage of medium to large property structures is extremely difficult to assess because each property tends to be almost unique in nature. However, such property types can be broken down at step 14 into a set of attributes. Harvesting and analysis at steps 16 and 18 performs a highly granular analysis of attribute risk from external unstructured information.

Customer Relationship Management Analytics

Present tools and processes attempt to predict customer behavior based upon results from internally generated functions based on historical take up rates compared to customer demographics. However strong sales in one geographic location, the New York area for example, can only lead to more emphasis on that area and perhaps a hypothesis that large cities may be a natural candidate for the product. According to one embodiment of the present invention, customer relationship analysis is performed by first selecting and grouping customer data at steps 12 and 14 as described above. The customers are grouped into a similar behavioral pattern for which market data is required. Data is harvested at step 16, and the results of the harvested data are used to build and test hypothesis correlations at step 18. For example, the analysis may seek to establish which type of customer is most likely to buy a particular product or service. Alternatively, an advertising agency or political organization may want to determine acceptance rates of specific marketing campaigns from an external perspective. The harvested data may identify external events such as an unusually dry summer or the lack of advertising in the region by primary competitors that correlates to the behavior of interest in the selected customers, e.g. likelihood that the selected customers will purchase the product or service in the above example. Based upon the results of the analysis, an action is taken to inform the analyst of the events that drive the behavior of interest.

Demand Forecasting

Taking the above example of customer management information analytics to the next level, the present invention can be used to enable better forecasting of customer demand. In all aspects of retail, manufacturing and the entire supply chain, higher demand than expected results in lost sales, while lower demand results in excess inventory. As one example under this arrangement, a product is identified for which a forecast is required. An existing forecast is obtained, or alternatively, a forecast is derived from processing internal data. Data is harvested at step 16 that is steered towards improving the accuracy of the forecast based on highly granular external drivers extracted from unstructured information. The improved analysis could have significant impact on bottom line results. The results of the analysis of harvested data at steps 16 and 18 are used to update the existing forecast at step 22.

Trading and Futures

The capabilities described above with reference to Demand Forecasting can also be applied to trading of securities, commodities or goods where the data harvested at step 16 is steered towards identifying supply and demand that is linked to activities reported in external unstructured sources. This can also be extended to the analysis of futures, which are multi-variate.

Miscellaneous

The present invention can be used in any application where it is desirable to establish common themes and trends from apparently unconnected events reported in unstructured sources. Additional examples include security/infrastructure activity tracking such as food or water supply contamination, virus outbreaks, common themes in automobile accidents, criminal behavior, and response to medications. The ability of the present invention to identify granular cause and effect relationships from unstructured information can also be applied to improve portfolio balance. For example, unemployment trends may affect Detroit differently from Silicon Valley, and differently from retirement communities in Florida. Changes in interest rates may have an opposite effect. Improvement in granular forecasting may allow a far more stable portfolio of customer types to be established which is better balanced across a range of external functions.

In addition to finding answers to internal results based upon external data, and improving or otherwise modifying predictive models, the methods discussed above with reference to FIGS. 1-10 may also be used to run “what-if” types of analysis and simulations to test the effects of changing operational parameters. Also, any steps or parts of the methods describes herein can be practiced manually or automatically, and may also be practiced entirely in a computer solution, or involve human interaction to accomplish one or more steps.

Having described the invention in detail and by reference to preferred embodiments thereof, it will be apparent that modifications and variations are possible without departing from the scope of the invention defined in the appended claims.

What is claimed is:

1. A method of analyzing information comprising:
identifying a group of interest from at least one data set;
harvesting data to identify that data which pertains to said group of interest;
constructing at least one hypothesis correlation between said group of interest and at least a portion of said data that has been harvested; and
using the results of at least one hypothesis correlation to trigger a response.

2. The method of analyzing information according to claim 1, wherein said group of interest comprises a group of items having similar behavioral patterns as measured over time.

3. The method of analyzing information according to claim 1, wherein said group of interest comprises representations of at least one larger data set of internal structured data.

4. The method of analyzing information according to claim 1, further comprising tagging an event of interest that relates to at least one item of said group of interest, wherein at least one hypothesis correlation is drawn between at least a portion of said data that has been harvested and said event of interest.

5. The method of analyzing information according to claim 4, wherein data is harvested from sources, and at least one hypothesis correlation is established that identifies a previously unknown relationship between some piece of said data harvested from sources and said event of interest.

6. The method of analyzing information according to claim 1, wherein harvesting is based upon predefined searching instructions to find additional information that relates to said group of interest.

7. The method of analyzing information according to claim 6, wherein said predefined searching instructions comprise providing instructions to harvest from at least one source.

8. The method of analyzing information according to claim 7, wherein said source comprises unstructured data.

9. The method of analyzing information according to claim 1, further comprising:
recursively harvesting additional data until a predefined stopping event occurs;
analyzing said additional data that has been harvested; and,
optionally modifying at least one hypothesis correlation based upon said additional data that has been harvested.

10. The method of analyzing information according to claim 9, wherein data is recursively harvested further based upon new keys derived from said data previously harvested.

11. The method of analyzing information according to claim 9, wherein said stopping event comprises at least one of an establishment of a relatively strong correlation, a predetermined number of iterations is reached, a predetermined processing time has been reached, and an operator interaction.

12. The method of analyzing information according to claim 1, further comprising:
constructing a watch event based upon at least one hypothesis correlation;
monitoring at least one source of information for a repetition of said watch event; and
triggering a response to a detected repetition of said watch event.

13. The method of analyzing information according to claim 12, wherein said watch event is established from a predictive model derived from at least one hypothesis correlation.

14. The method of analyzing information according to claim 13, wherein said predictive model is created initially from at least a portion of said data set and is optionally updated by said data that has been previously harvested.

15. The method of analyzing information according to claim 13, wherein said predictive model is created based upon said data that has been previously harvested.

16. The method of analyzing information according to claim 14, wherein said watch event indicates specific behavior within said group of interest.

17. The method of analyzing information according to claim 13, wherein said predictive model comprises at least one of trend detection, pattern detection, anomaly detection, multi-query comparison, web harvesting and characterization, querying of long documents, and relationships revealed without need for prior knowledge.

18. The method of analyzing information according to claim 13, wherein said predictive model is built by identifying at least one of trends, relationships, events, and threads.

19. The method of analyzing information according to claim 13, wherein said predictive model explains an event of interest based upon said group of interest and said data that has been harvested.

20. The method of analyzing information according to claim 13, further comprising predicting future events of interest based upon said predictive model.

21. The method of analyzing information according to claim 13, wherein ones of the harvested data affecting said predictive model define driving events and wherein unstructured data is harvested to adaptively build at least one relationship between said group of interest and said driving events.

22. The method of analyzing information according to claim 21, wherein said predictive model comprises statistical analysis of at least one of said group of interest, an event of interest, and said driving events.

23. The method of analyzing information according to claim 12, further comprising generalizing said watch event to extend to different groups from said at least one data set of internal data.

24. The method of analyzing information according to claim 1, further comprising collecting data that has been harvested into a common data store.

25. The method of analyzing information according to claim 24, wherein internal data from said group of interest and said data that has been harvested is collected in said data store by linking without need for using a predefined data format.

26. The method of analyzing information according to claim 1, wherein said harvesting comprises using a harvester running as a software component to collect data from data sources in at least a partially automated fashion.

27. The method of analyzing information according to claim 26, wherein said harvester follows a predetermined set of directives.

28. The method of analyzing information according to claim 26, wherein said harvester comprises at least one of a software agent, spider, web crawler, and software robot.

29. The method of analyzing information according to claim 26, wherein said harvester utilizes at least one of dynamic queries driven by data previously harvested and query driven by collected/expanded data to search at least one of bounded data sets and unbounded data sets.

30. The method of analyzing information according to claim 1, wherein all steps subsequent to selecting said group of interest are automatically performed on a computer system

31. A method of analyzing information comprising:
organizing structured records into at least a first category and a second category;
analyzing at least a portion of said data set to determine a group of interest based upon ones of said records having similarities within said first category against at least one predetermined criteria;
reiteratively processing by:
harvesting additional data;
deriving a correlation between said additional data harvested and said group of interest; and
determining whether additional keys are available in said data; and
making a decision based upon said correlation.

32. The method according to claim 31, further comprising:
defining at least one aspect associated with said correlation as a watch event:
monitoring at least one source of information for said watch event; and,
triggering a response upon detection of said watch event.

33. A method of analyzing information comprising:
organizing structured internal records from a data set into at least a behavioral items category and a keys category;
analyzing at least a portion of said data set to determine a group of interest based upon ones of said records having similar behavioral patterns within said behavior items category;
determining keys from said keys category that are associated with said group of interest;
reiteratively processing by:
harvesting additional data;
determining whether a correlation exists between said additional data that has been harvested and said group of interest; and,
determining whether additional keys are available in said data;
defining at least one aspect associated with said correlation as a watch event;
monitoring at least one data source for repetition of said watch event; and,
triggering a response upon recognition of said watch event.

34. A method of analyzing information comprising:
organizing structured internal records from at least one data set into at least a behavioral items category and a keys category;
analyzing at least a portion of said data set to determine a group of interest based upon ones of said records having similar behavioral patterns within said behavior items category;
identifying an event of interest that relates to said group of interest;
determining keys from said keys category that are associated with said group of interest;
harvesting additional data from any combination of internal and data sources;
determining whether a correlation exists between said additional data that has been harvested and said group of interest that identifies a previously unknown relationship between some piece of said data harvested and said event of interest;
defining at least one aspect associated with said correlation as a watch event;
monitoring at least one source of data for repetition of said watch event; and
triggering a response upon recognition of said watch event.

35. A method of analyzing information comprising:
deriving a predictive model based upon internal data;
identifying hypothesis keys;
harvesting data based upon at least one of said keys;
modifying said predictive model based upon said data previously harvested; and
using said predictive model to trigger a response to an event of interest.

36. The method of analyzing information according to claim 35, wherein said predictive model is derived from a previously established enterprise model.

37. The method of analyzing information according to claim 35, wherein said predictive model is derived specific to an event of interest.

38. The method of analyzing information according to claim 35, further comprising:
organizing internal data into a plurality of groups and keys associated therewith;
identifying a group of interest from said plurality of groups; and,
tagging an event of interest, wherein said predictive model is directed by said event of interest.

39. The method of analyzing information according to claim 35, further comprising:
performing an analysis to ascertain the ability of said data previously harvested to improve said predictive model; and,
modifying said predictive model where said predictive model can be improved based upon said data previously harvested.

40. The method of analyzing information according to claim 35, further comprising recursively harvesting additional data until a predefined stopping event occurs, said additional data analyzed to determine whether said predictive model is affected thereby.

41. The method of analyzing information according to claim 35, further comprising identifying a watch event based upon said predictive model and monitoring sources for indication of said watch event.

42. The method of analyzing information according to claim 41, further comprising triggering an action based upon the detection of said watch event.

43. A method of analyzing information comprising:
organizing data into a plurality of groups;
identifying group of interest from said data;
deriving at least one hypothesis correlation based upon said data;
identifying hypothesis keys;
harvesting data based upon at least one of said hypothesis keys;
performing an analysis to ascertain the ability of said data previously harvested to improve any derived hypothesis correlation;
updating any hypothesis correlation improved by the harvested data;
identifying a watch event based upon at least one hypothesis correlation;
monitoring sources for indication of said watch event; and
triggering a response to said watch event.

44. The method of analyzing information according to claim 43, further comprising:
recursively harvesting additional data until a predefined stopping event occurs; and
updating said watch event based upon said additional data that has been harvested.

45. A method of performing financial risk assessment comprising:
identifying a group of customers having a similar behavior of interest from at least one data set, said similar behavior of interest relating to a factor that influences an assessment of risk for said group of customers;
harvesting external data that pertains to said group of customers;
constructing at least one hypothesis correlation that identifies at least one factor from at least one external source that influences said assessment of risk for said group of customers; and
using the results of at least one hypothesis correlation to update at least one measure of financial risk.

46. The method of performing financial risk assessment according to claim 45, wherein data is harvested to determine granular risk profiles by a predetermined attribute.

47. The method of performing financial risk assessment according to claim 45, wherein said group of customers comprise a group of insurance policy holders

48. A method of performing customer relations information analysis comprising:
identifying a group of customers having a similar market behavior of interest from at least one data set, said similar behavior of interest related to a desired market data;
harvesting data to identify data that pertains to said group of customers;
constructing at least one hypothesis correlation that identifies at least one factor from at least one external source that drives said similar market behavior of interest of said group of customers; and
reporting external events that drive said similar market behavior of interest for said group of customers.

49. A method of performing demand forecasting comprising:
identifying a product of interest for which a forecast is required;
establishing a forecast for said product based upon internal data;
harvesting external data that pertains to said product of interest;
steering the harvesting of external data towards improving the accuracy of said forecast;
constructing at least one hypothesis correlation that identifies at least one factor from at least one external source that influences said assessment of risk for said group of customers; and
using the results of at least one hypothesis correlation to update said forecast.

50. The method of performing demand forecasting according to claim 49, wherein the harvesting is steered towards improving the accuracy of the forecast based on highly granular external drivers extracted from unstructured information.

51. The method of performing demand forecasting according to claim 49, wherein the harvesting is steered towards identifying supply and demand that is linked to activities reported in external unstructured sources relating to an activity selected from the group consisting of the trading of securities, commodities and goods.

52. The method of performing demand forecasting according to claim 49, wherein the harvesting is steered towards identifying supply and demand that is linked to activities reported in external unstructured sources relating to the analysis of futures which are multi-variate.

53. A system for analyzing information comprising:
at least one processor;
at least one storage device communicably coupled to said at least one processor arranged to store structured and unstructured data;
software executable by said at least one processor for:
organizing data into a plurality of groups and keys associated therewith;
storing said data within at least one storage device;
interacting with a user to identify group of interest from said internal data;
harvesting data based upon at least one of said keys;
determining whether a correlation exists between said data previously harvested and said group of interest; and
using said correlation to trigger a response.

54. The system for analyzing information according to claim 53, wherein said at least one storage device is arranged to store unstructured as well as structured data without requiring a predefined file format.

55. The system for analyzing information according to claim 53, further comprising recursively harvesting any combination of internal and unstructured data until a predefined stopping event occurs, said unstructured data analyzed to determine whether said correlation is affected thereby.

56. The system for analyzing information according to claim 53, further comprising:
determining a triggering event based upon said predictive model;
monitoring for said triggering event; and
triggering a response to said triggering event.

57. The system for analyzing information according to claim 53, further comprising:
creating a predictive model based upon said correlation;
identifying a watch event based upon said predictive model; and
monitoring sources for indication of said watch event.

58. The system for analyzing information according to claim 57, further comprising automatically triggering an action based upon the detection of said watch event.

59. The system for analyzing information according to claim 53, wherein harvesting comprises using a harvester running as a software component to collect data from data sources in at least a partially automated fashion.

60. The system for analyzing information according to claim 59, wherein said harvester comprises at least one of a software agent, spider, web crawler, and software robot.

61. A computer system for analyzing information comprising:
at least one storage device having structured data stored thereon;
at least one processor coupled to said at least one storage device programmed to perform analysis of information and take action in response to the results of the analysis by executing program code to:
organize data into a plurality of groups and keys associated therewith;
store said data within said storage device;
interact with a user to identify a group of interest from said data;
harvest data based upon at least one of said keys;
derive a correlation based upon said data previously harvested and said group of interest; and,
use said correlation to trigger a response.

62. The computer system according to claim 61, wherein said processor is further programmed to monitor sources of information for a watch event derived from said correlation, and trigger said response thereto.

63. A system for analyzing information comprising:
at least one processor;
at least one storage device communicably coupled to said at least one processor arranged to store structured and unstructured data;
software executable by said at least one processor for:
organizing data from at least one data set into a plurality of groups;
identifying a group of interest from said plurality of groups;
deriving at least one hypothesis correlation based upon said data identifying hypothesis keys;
harvesting data based upon at least one of said hypothesis keys;
performing an analysis to ascertain the ability of said data previously harvested to improve any hypothesis correlation;
updating any hypothesis correlation improved by the harvested data;
identifying a watch event based upon at least one hypothesis correlation;
monitoring sources for indication of said watch event; and
triggering a response to said watch event.

64. The system of analyzing information according to claim 63, further comprising:
recursively harvesting additional data until a predefined stopping event occurs; and,
updating said watch event based upon said additional data that has been harvested.

65. A computer readable carrier including information analysis program code that causes a computer to perform operations comprising:
organizing data into a plurality of groups and keys associated therewith;
identifying group of interest from said internal data;
harvesting data based upon at least one of said keys;
deriving a correlation between said data previously harvested and said group of interest; and
using said correlation to trigger a response.
